(19) United States
(12) Patent Application Publication
(10) Pub. No.: US 2005/0150706 A1
(43) Pub. Date: Jul. 14, 2005

(54) Fuel injection system and related structure for a four-wheeled saddle-type vehicle

(75) Inventors: Masataka Eguchi, Saitama (JP); Kazuhiro Hotta, Saitama (JP); Atsushi Ito, Saitama (JP)

Correspondence Address: CARRIER BLACKMAN AND ASSOCIATES, 24101 NOVI ROAD, SUITE 100, NOVI, MI, 48375, US

(73) Assignee: Honda Motor Co., Ltd., Tokyo (JP)

(21) Appl. No.: 11/031,958

(22) Filed: Jan. 7, 2005

(30) Foreign Application Priority Data
Jan. 9, 2004 (JP) 2004-003771

(51) Int. Cl. B60K 8/00; B60K 1/00

(52) U.S. Cl. 180/291

(57) ABSTRACT

A saddle riding type four-wheeled vehicle, suitable for rough terrain running, includes an engine having an electronically controlled fuel injection system. The vehicle also includes a throttle body disposed in back of a cylinder head of the engine. This configuration substantially protects the engine from drawing in mud, dust, and the like, and also eliminates the need for a protector of a throttle body. The fuel pump unit of the fuel injection system integrates the fuel pump, the fuel filter, and the pressure regulator into a single housing, to simplify the fuel piping required to connect different parts of the fuel supply system, as compared with conventional structures. This facilitates procedures of removing and installing the fuel tank and the fuel pump unit. The feature also reduces pumping loss of the fuel pump as well as parts cost.

### CROSS-REFERENCE TO RELATED APPLICATIONS

The present invention claims priority under 35 USC 119 based on Japanese Patent Application Number 2004-003771, filed on Jan. 9, 2004. The subject matter of the referenced priority document is incorporated by reference herein.

### BACKGROUND OF THE INVENTION

1. Field of the Invention

The present invention relates to an electronically controlled fuel injection system and related structure for a saddle riding type four-wheeled vehicle suitable for off-road operation on rough terrain.

2. Description of the Background Art

A carburetor type fuel supply system is commonly found in saddle riding type four-wheeled vehicles suitable for operation on rough terrain, which are sometimes called all terrain vehicles (ATV). In ordinary saddle riding type vehicles, such as motorcycles and the like, a common trend is toward adopting an electronically controlled fuel injection system as a fuel supply system, such as that disclosed, for example, in Japanese Utility Model Laid-open No. Hei 2-127779.

If a carburetor is used in the fuel supply system, the construction of the carburetor can at times become complicated. This includes consideration of startability of an engine in cold regions, where the rough terrain running saddle riding type four-wheeled vehicles are uniquely used. There is, therefore, a demand for adopting an electronically controlled fuel injection system in the fuel supply system for use on saddle riding type four-wheeled vehicles suitable for operation on rough terrain. It is herein desirable that an arrangement be made which substantially protects the engine from drawing in mud, dust, and the like during running on rough terrain and eliminates the need for a throttle body protector for protecting a throttle body from plants and other obstacles.

It is therefore an object of the present invention to provide a saddle riding type four-wheeled vehicle suitable for operation on rough terrain which employs an electronically controlled fuel injection system in a fuel supply system and having an arrangement that substantially protects the engine from drawing in mud, dust, and the like and eliminates the need for a throttle body protector.

### SUMMARY OF THE INVENTION

To achieve the foregoing object, according to a first aspect of the present invention, there is provided a saddle riding type four-wheeled vehicle suitable for operation on rough terrain. The vehicle adopts an electronically controlled fuel injection system in a fuel supply system for an engine mounted thereon. The vehicle is characterized in that a throttle body is disposed rearwardly of a cylinder head of the engine.

As a result, according to a second aspect of the present invention, the throttle body and an air cleaner are disposed, in that order, behind the engine cylinder head. This arrangement substantially protects the engine from drawing in mud, dust, and the like during running on rough terrain. The placement of the throttle body rearwardly of an engine main body substantially shields the throttle body, and prevents the throttle body from contacting an obstacle, such as plants, sticks, or the like.

According to a third aspect of the present invention, a fuel pump unit is disposed in front of the engine. The fuel pump unit integrally includes a fuel pump, a fuel filter, and a pressure regulator. This configuration simplifies the piping that connects different parts of the fuel supply system, as compared with a structure in which the fuel pump, the fuel filter, and the pressure regulator are separately provided.

According to the first and the second aspects of the present invention, the engine is less likely to draw mud or dust when operated on rough terrain. This, in particular, keeps the air cleaner in good condition, and reduces the number of man-hours required for maintenance. In addition, the throttle body is less likely to contact obstacles, such as plants and the like. This eliminates the need for the protector or similar device for the throttle body, thus contributing to reduced vehicular weight and cost. Furthermore, the adoption of the electronically controlled fuel injection system improves startability of the engine in applications in cold regions.

According to the third aspect of the present invention, the piping connecting different parts of the fuel supply system can be simplified. This facilitates the procedures of removing and installing the fuel tank and the fuel pump. The feature also reduces pumping loss of the fuel pump, as well as parts cost.

Modes for carrying out the present invention are explained below by reference to an exemlary illustrative embodiment of the present invention shown in the attached drawings. The above-mentioned object, other objects, characteristics and advantages of the present invention will become apparent form the detailed description of the embodiment of the invention presented below in conjunction with the attached drawings.

### BRIEF DESCRIPTION OF THE DRAWINGS

FIG. 1 is a side elevational view of a saddle riding type four-wheeled vehicle according to an illustrative embodiment of the present invention, suitable for operation on rough terrain and showing the fuel pump positioned in front of the engine, and the throttle body of the fuel injector positioned rearward of the engine.

FIG. 2 is a top plan view of the saddle riding type four-wheeled vehicle of FIG. 1, showing the relative positions of the fuel pump unit, the gas tank, the throttle body, and the air cleaner in the space provided within the vehicle frame.

FIG. 3 is a front elevational view of the saddle riding type four-wheeled vehicle of FIG. 1, showing the orientation of the cylinder and cylinder head relative to the crankcase within the space portion of the vehicle frame.

FIG. 4 is an enlarged view of the fuel system of the saddle riding type four-wheeled vehicle of FIG. 1.

FIG. 5 is a side elevational view of the fuel pump unit showing the fuel filter, fuel pump, and fuel pressure regulator integrated into a single housing.

FIG. 6 is a top view showing the fuel pump unit of FIG. 5; and

FIG. 7 is a side elevational view of the fuel pump unit as seen in the direction of arrow A of FIG 5.

### DETAILED DESCRIPTION

An illustrative embodiment of the present invention will be described hereunder with reference to the accompanying drawings. In the description that follows, the directions of front to rear, and right to left, correspond to those of the vehicle. In the drawings, an arrow FR indicates a forward direction of the vehicle, while an arrow LH indicates a leftward direction of the vehicle.

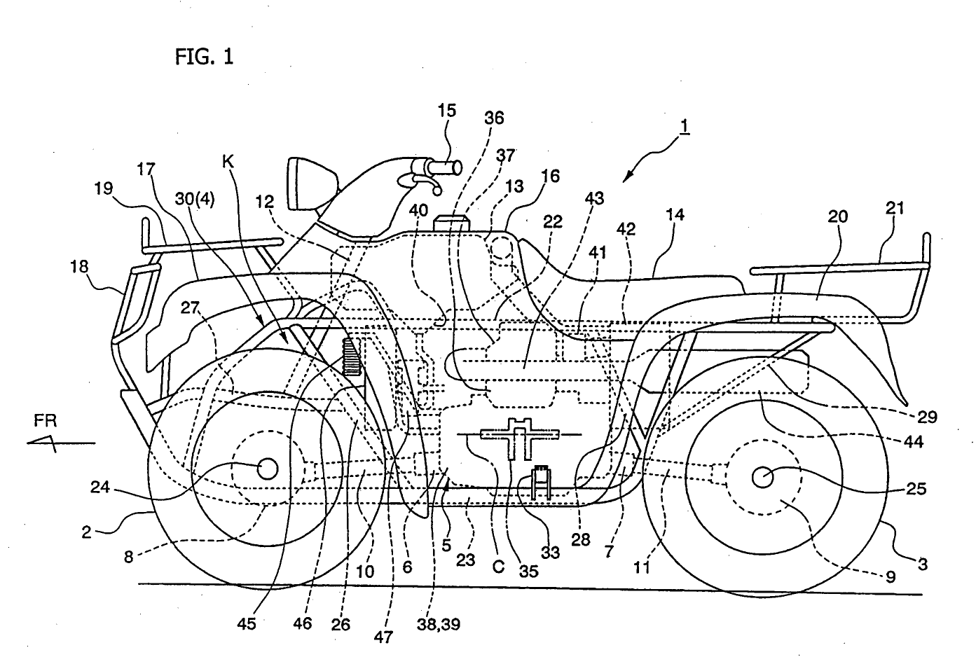

The saddle riding type four-wheeled vehicle 1 shown in FIG. 1 is suitable for operation on rough terrain, and includes a pair of right and left front wheels 2 and rear wheels 3 mounted at front and rear of a vehicle body of a compact and lightweight structure. Each of the front wheels 2 and the rear wheels 3 is a low-pressure balloon tire having a relatively large diameter. The vehicle 1 is provided with ample road clearance thanks to the described configuration. The vehicle 1 is an ATV specifically designed for enhanced running performance on rough terrain. Each of the pair of the front wheels 2 and the pair of the rear wheels 3 is suspended by a suspension system (not shown) at a front portion and a rear portion, respectively, of a vehicle body frame 4. An engine 5 is mounted at substantially a center position of the vehicle body frame 4. A front output shaft 6 and a rear output shaft 7 are mounted at front and rear of the engine 5, respectively. The output shafts 6, 7 are coupled to a front wheel drive mechanism 8 and a rear wheel drive mechanism 9 via a front drive shaft 10 and a rear drive shaft 11, respectively. A driving force of the engine 5 is transmitted to the front wheels 2 and the rear wheels 3 via the drive shafts 10, 11 and the drive mechanisms 8, 9, respectively.

In order, from the front of the vehicle body toward rear, a steering shaft 12, a fuel tank 13, and a saddle riding seat 14 are disposed at a center portion in a direction of width of the saddle riding type four-wheeled vehicle 1. A steering mechanism (not shown) for steering the front wheels 2 is connected to a lower end portion of the steering shaft 12. A handlebar 15 is attached to an upper end portion of the steering shaft 12. A vehicle body cover 16 and a front fender 17 are mounted on a front portion of the vehicle body frame 4. The vehicle body cover 16 is made of resin, covering the front portion of the vehicle body including the fuel tank 13. The front fender 17 is also made of resin, and covers each of the front wheels 2. Further, a front protector 18 and a front carrier 19, mainly made of steel pipes, are attached forward of the steering shaft 12. A rear fender 20, made of resin, for covering each of the rear wheels 3 is mounted in a rear portion of the vehicle body frame 4. In addition, a rear carrier 21, mainly made of steel pipes, is attached rearward of the saddle riding seat 14.

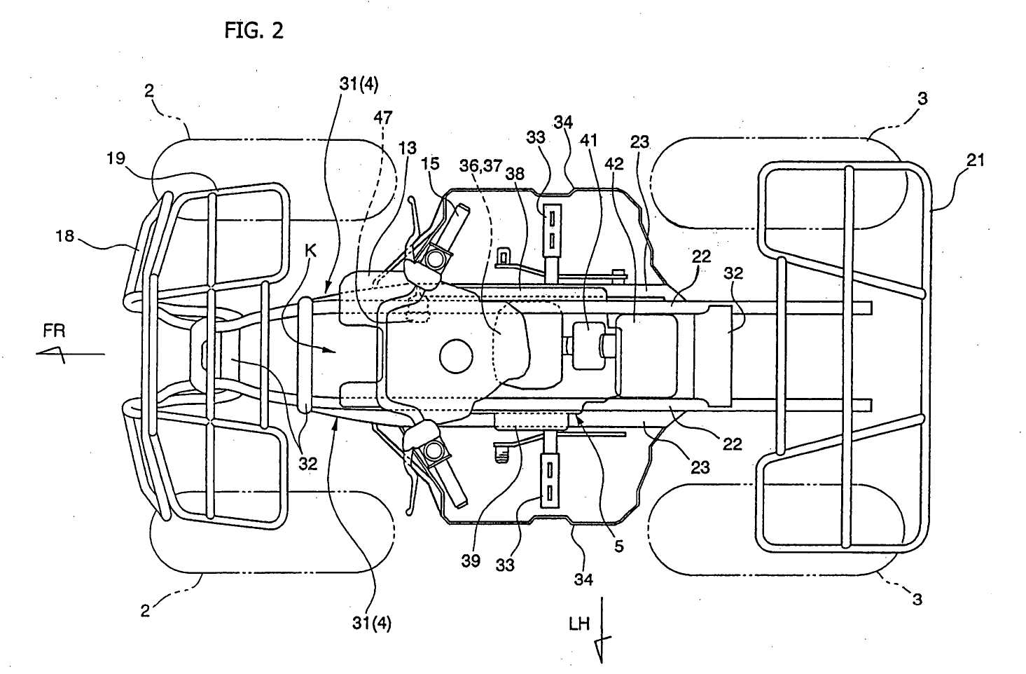

The vehicle body frame 4 will now be described with reference to FIGS. 1 and 2. A pair of right and left upper pipes 22 and a pair of right and left lower pipes 23 are disposed on an upper portion and a lower portion, respectively, of the vehicle body frame 4. The upper pipes 22 and the lower pipes 23 extend substantially in a fore and aft direction. A front portion of each of the upper pipes 22 curves downwardly at a forward position of the steering shaft 12. A lower end of the front portion of each of the upper pipes 22 is joined to a front end portion of each of the lower pipes 23.

Further, a rear portion of each of the lower pipes 23 curves upwardly at a rearward position of the engine 5. An upper end of the rear portion of each of the lower pipes 23 is joined to a rear portion of each of the upper pipes 22. As such, a closed loop structure is formed by the upper pipes 22 and the lower pipes 23 as viewed from the side. The lower pipes 23 are situated slightly downward from a front axle 24 and a rear axle 25. The front axle 24 serves as a center axis of rotation of the front wheels 2. The rear axle 25 serves as a center axis of rotation of the rear wheels 3. Areas around the lower pipes 23 form a portion of the minimum road clearance of the vehicle body.

An upper end portion of a front tension pipe 26 is joined to a curved portion of each of the upper pipes 22. A lower end portion of the front tension pipe 26 is joined to a portion more toward a center in the fore and aft direction of each of the lower pipes 23. A rear end portion of a front sub-pipe 27 is joined to an intermediate portion of the front tension pipe 26. The front sub-pipe 27 extends substantially horizontally and a front end thereof is joined to each of the lower pipes 23. A lower end of a rear tension pipe 28 is joined to a curved portion of each of the lower pipes 23 from a front side thereof. An upper end of the rear tension pipe 28 is joined to a portion more toward a center in the fore and aft direction of each of the upper pipes 22. Further, a lower end of a rear sub-pipe 29 is joined to the curved portion of each of the lower pipes 23 from a rear side thereof. An upper end of the rear sub-pipe 29 is joined to a rear end portion of each of the upper pipes 22.

Main frame members, including the left upper pipe 22, the left lower pipe 23, each tension pipe, and each sub-pipe, form a left-hand-side frame portion 30 which comprise a left-hand half of the vehicle body frame 4. Similarly, main frame members, including the right upper pipe 22, the right lower pipe 23, each tension pipe, and each sub-pipe, form a right-hand-side frame portion 31 which comprise a right-hand half of the vehicle body frame 4. Further, the left-hand-side frame portion 30 and the right-hand-side frame portion 31 are integrally connected together by way of a plurality of cross members 32 placed along the vehicle width direction.

The vehicle body frame 4, forming a long, robust box structure extending in the fore and aft direction, is thereby configured at the center portion in the vehicle width direction. A space portion K is formed at the center portion in the vehicle width direction so as to be enclosed by the various members which comprise the vehicle body frame 4 and is sandwiched between the left-hand-side frame portion 30 and the right-hand-side frame portion 31. A front end portion of the vehicle body frame 4 (a front end portion of the space portion K) extends up to a forward position of the front axle 24.

A reference numeral 33 represents a step for a rider of the vehicle. The step 33, and a board frame 34 provided so as to surround the step 33, allow a step board (not shown) to be mounted to the vehicle body frame 4.

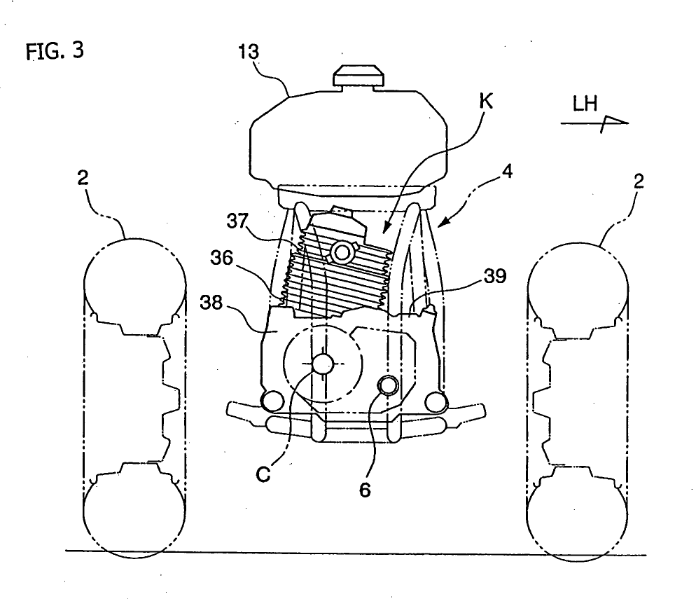

Reference is now made to FIG. 3, which is a front elevational view of the saddle riding type four-wheeled vehicle of FIG. 1, with selected components omitted from the drawing for illustrative purposes, and showing the orientation of the cylinder 36 and cylinder head 37 relative to the crankcase 38, within the space portion K of the vehicle body frame 4. The engine 5 may be, for example, an air-cooled, single-cylinder reciprocating engine. The engine 5 is disposed in the space portion K within the vehicle body frame 4. The engine 5 may, alternatively, be formed as a water-cooled engine, or a multi-cylinder engine. The engine 5 is longitudinally mounted. That is, the engine 5 is disposed so as to run along the fore and aft direction, with a rotation axis C of a crankshaft 35 thereof slightly deviated toward the right from the center in the vehicle width direction.

A cylinder 36 of the engine 5, and the cylinder head 37 which overlies the cylinder 36, are disposed on an upper portion of a crankcase 38, and are inclined relative to the vertical. Specifically, the upper portion of the cylinder 36 and the cylinder head 37 lean to the left of the vehicle relative to the lower portion of the cylinder 36. A transmission case 39 accommodating a transmission (not shown) is integrally formed on the left-hand side of the crankcase 38. The output shafts 6, 7 are disposed so as to protrude from a front wall and a rear wall, respectively, of the transmission case 39 at a position slightly deviated to the left from the center in the vehicle width direction. The output shafts 6, 7 are found at the front and rear of the transmission case 38, respectively.

Referring to FIG. 1, the cylinder 36 and the cylinder head 37 are disposed substantially at the center in the fore and aft direction as viewed from a side. Herein, the fuel tank 13 is located above the space portion K of the vehicle body frame 4 at the front of the vehicle. The cylinder 36 and the cylinder head 37 are thus disposed obliquely below the fuel tank 13. The fuel tank 13 is, for example, a one-piece molding of a resin. A front portion of the fuel tank 13 may, for example, be bifurcated to sandwich the steering shaft 12. The fuel tank 13 may otherwise be formed into a desired shape so as to provide a sufficient capacity, while circumventing surrounding parts (see FIG. 2). A lowermost end portion 40 is formed on an underside of the fuel tank 13. The lowermost end portion 40 protrudes downwardly at about a center of the fuel tank 13 in the fore and aft direction. Herein, the lowermost end portion 40 of the fuel tank 13 is located behind the front axle 24, or the rotation axis of the front wheels 2, and in front of the engine 5.

The engine 5 mounted on the rough terrain running saddle riding type four-wheeled vehicle 1 employs an electronically controlled fuel injection system in a fuel supply system thereof. The throttle body 41 is connected to a rear portion of the cylinder head 37. That is, a rear side of the cylinder head 37 comprises an intake side of the cylinder head 37. The air cleaner 42 is connected to a rear portion of the throttle body 41. The throttle body 41 and the air cleaner 42 are disposed rearwardly of the cylinder head 37 and inside the space portion K of the vehicle body frame 4 (see FIG. 2). An exhaust pipe 43 is connected to an exhaust side, or a front portion, of the cylinder head 37. The exhaust pipe 43 is curved to extend toward the rear and is connected to a muffler 44 supported by the rear portion of the vehicle body frame 4.

In order from the front side of the vehicle body, an oil cooler 45, a cooling fan 46, and a fuel pump unit 47 to be described later, are disposed downward of the fuel tank 13. The oil cooler 45 is for cooling the engine oil. The cooling fan 46 forcedly cools the engine 5. The fuel pump unit 47 is located substantially immediately below the lowermost end portion 40 of the fuel tank 13 and inside the space portion K of the vehicle body frame 4. That is, the fuel pump unit 47 is located rearward of the front axle 24 of the front wheels 2 and in front of the engine 5. In addition, the fuel pump unit 47 is disposed at a portion between the engine 5 and the cooling fan 46 and more on the side of the cooling fan 46. Further, as shown in FIG. 2, the fuel pump unit 47 is disposed near the right-hand-side frame portion 31 inside the space portion K of the vehicle body frame 4 as viewed from above.

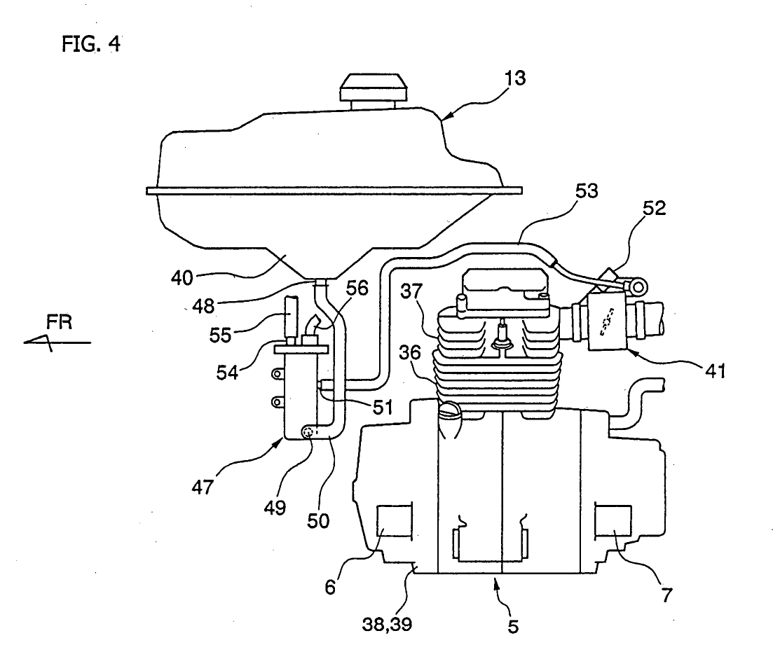

Referring now to FIG. 4, a fuel outlet port 48 is disposed on the lowermost end portion 40 of the fuel tank 13. The fuel outlet port 48 is connected to a fuel inlet port 49 at a lower portion of the fuel pump unit 47 via a first fuel hose 50. A fuel delivery port 51 is provided in a rear portion of the fuel pump unit 47. The fuel delivery port 51 and an injector (a fuel injection valve) 52 provided in the throttle body 41 are connected together through a second fuel hose 53. In addition, a fuel return port 54 is provided on an upper portion of the fuel pump unit 47. The fuel return port (vapor release port) 54 and a predetermined return port (drawing omitted) of the fuel tank 13 are connected together through a third fuel hose 55. A reference numeral 56 represents a power supply harness for the fuel pump unit 47.

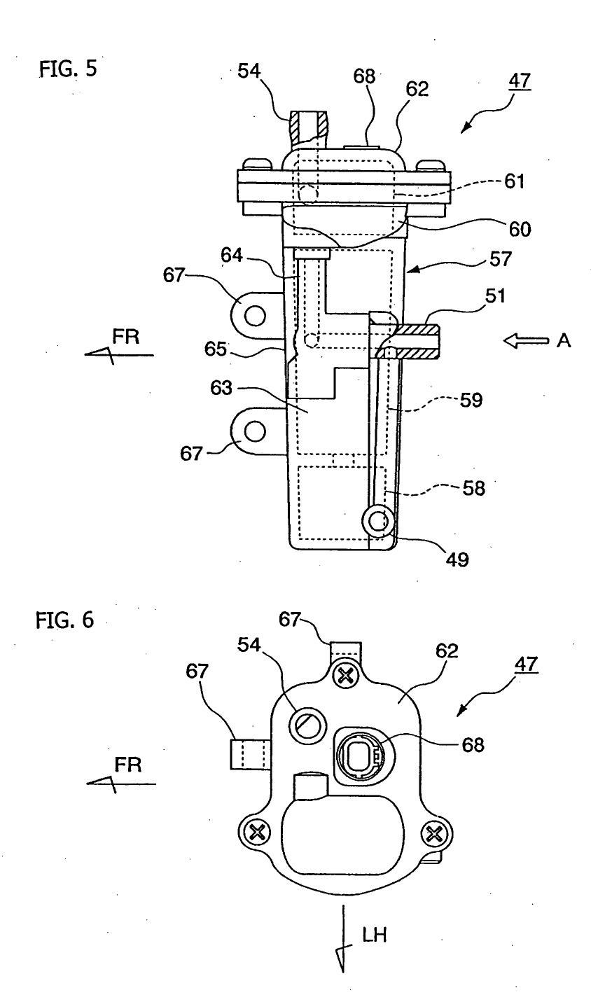

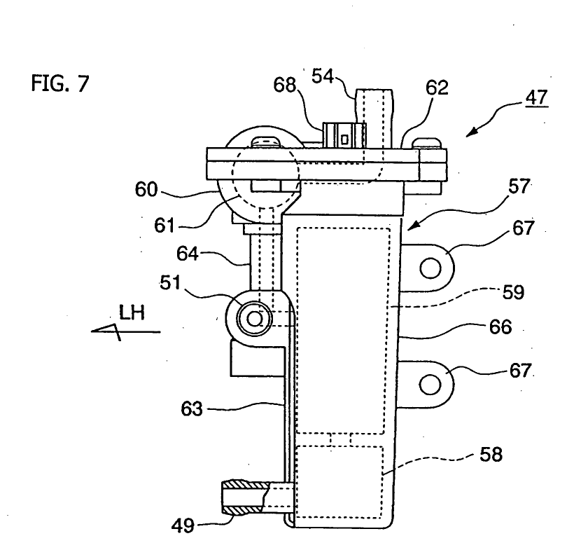

Referring to FIGS. 5 through 7, the fuel pump unit 47 includes a case main body 57 having substantially a shape of a rectangular parallelepiped that is vertically long on an outside thereof. The fuel filter 58 and the fuel pump 59 are housed in the case main body 57, in that order from a lower side thereof. The pressure regulator 61 is accommodated in an annexed chamber 60 provided on an upper portion on the left side of the case main body 57. An upper opening in the case main body 57 is then closed with a cover 62. Thus, the fuel pump unit 47 integrates the fuel filter 58, the fuel pump 59, and the pressure regulator 61.

A communication path 64 is provided on an outside on a left side wall 63 of the case main body 57. The communication path 64 brings substantially a center portion of the fuel pump 59 in the vertical direction into fluid communication with the pressure regulator 61. The fuel delivery port 51 protruding rearwardly is disposed on a lower end portion of the communication path 64. The fuel inlet port 49 protruding leftwardly is disposed on the lower end portion of the left side wall 63 of the case main body 57.

In addition, a pair of upper and lower mounting brackets 67 is provided on a front wall 65 and a right side wall 66, respectively, of the case main body 57. The mounting brackets 67 are provided for fixing the fuel pump unit 47 to, for example, a shroud of the cooling fan 46. A plug 68 and the fuel return port 54 protruding upwardly are provided on the cover 62. The plug 68 is used for connecting a connector on a leading end of the power supply harness. The fuel return port 54 and an upper portion of the fuel pump 59 are brought into communication with each other through an air breather valve (not shown).

A path extending from the fuel pump 59 to the fuel delivery port 51 is connected to the communication path 64. The pressure of the fuel delivered from the fuel delivery port 51 can be adjusted to a predetermined level by the pressure regulator 61. When the fuel pump 59 is operated, fuel delivered from the fuel tank 13 is introduced through the fuel inlet port 49 at the lower portion of the case main body 57. The fuel then flows past the fuel filter 58 into the fuel pump 59. The fuel is then boosted to a predetermined fuel pressure and then delivered toward the injector 52 from the fuel delivery port 51. At this time, the pressure of the fuel delivered from the fuel delivery port 51 is adjusted to the predetermined pressure value by the pressure regulator 61. The injector 52 is therefore supplied at all times with fuel having the predetermined fuel pressure. An excess fuel from the pressure regulator 61 is returned to the fuel tank 13 through the fuel return port 54 (see FIG. 4). A fuel vapor produced in the fuel pump 59 moves upward of the fuel pump 59 through buoyancy of its own and is released through the fuel return port 54 by way of the air breather valve (not shown).

According to the illustrative embodiment of the present invention described in the foregoing, the rough terrain running saddle riding type four-wheeled vehicle 1 employing the electronically controlled fuel injection system in the fuel supply system of the engine 5 mounted thereon is provided. In this vehicle 1, the throttle body 41 and the air cleaner 42 are disposed rearwardly of the cylinder head 37 of the engine 5. More specifically, the throttle body 41 and the air cleaner 42 are disposed in that order rearward from the cylinder head 37 of the engine 5.

As a result, the engine 5 is less likely to draw mud or dust when operated on rough terrain. This, in particular, keeps the air cleaner 42 in good conditions and reduces the number of man-hours required for maintenance. In addition, the throttle body 41 is disposed rearwardly of the engine 5. The throttle body 41 is therefore less likely to contact obstacles, such as plants and the like. This eliminates the need for a protector or similar device for the throttle body 41, thus contributing to a reduced vehicular weight and cost. Another aspect to be noted is that the front side of the cylinder head 37 is the exhaust side. This allows the cylinder head 37 and the exhaust pipe 43 to be favorably cooled by the wind generated during operation of the vehicle and by the cooling fan 46. Moreover, as compared with the carburetor method employed in the fuel supply system, startability of the engine 5 is improved for applications in cold regions that are unique to the rough terrain running saddle riding type four-wheeled vehicle 1.

The saddle riding type four-wheeled vehicle 1 suitable for operation on rough terrain has, positioned in front of the engine 5, the fuel pump unit 47 integrating the fuel pump 59, the fuel filter 58, and the pressure regulator 61. This configuration simplifies the piping required to connect different parts of the fuel supply system, as compared with a structure in which the fuel pump, the fuel filter, and the pressure regulator are separately provided. This facilitates procedures of removal and installation of the fuel tank 13 and the fuel pump unit 47. The feature also reduces pumping loss of the fuel pump 59 as well as parts cost.

It should be noted that the present invention is not limited to the illustrative embodiment described in the foregoing. The present invention is applicable to, for example, a rough terrain running saddle riding type four-wheeled vehicle operating on a two-wheel drive or having a system selecting either a two-wheel drive or a four-wheel drive mode. The present invention may even be applicable to a saddle riding type four-wheeled vehicle suitable for operation on rough terrain having a transversely mounted engine, in which the rotation axis of a crankshaft thereof runs in parallel with the vehicle width direction. It should further be understood that the foregoing illustrative embodiment of the present invention is described by way of an example and that various changes and modifications may be made in the present invention without departing from the spirit and scope thereof.

1. A saddle riding type four-wheeled vehicle suitable for operation on rough terrain, said vehicle comprising an engine, the engine comprising a fuel supply system and a cylinder head, the fuel supply system comprising an electronically controlled fuel injection system and a throttle body, wherein
the throttle body is disposed rearwardly of the cylinder head of the engine.

2. A saddle riding type four-wheeled vehicle suitable for operation on rough terrain, said vehicle comprising a frame and an engine mounted thereon, the engine comprising a cylinder head and an electronically controlled fuel injection system in a fuel supply system, wherein the electronically controlled fuel injection system comprises a throttle body and an air cleaner, and wherein
the throttle body and the air cleaner are disposed in that order toward the rear of the vehicle relative to the cylinder head of the engine.

3. The saddle riding type four-wheeled vehicle according to claim 1,
wherein a fuel pump unit is disposed in front of the engine, the fuel pump unit comprising a fuel pump, a fuel filter, and a pressure regulator.

4. The saddle riding type four-wheeled vehicle according to claim 2,
wherein a fuel pump unit is disposed in front of the engine, the fuel pump unit comprising a fuel pump, a fuel filter, and a pressure regulator.

5. A four-wheeled all terrain vehicle comprising an engine positioned substantially mid way between a front end and a rear end of the vehicle, the vehicle further comprising a fuel supply system wherein
the fuel supply system comprises an electronically controlled fuel injector and a fuel pump unit, wherein the fuel injector is positioned rearward of the engine and the fuel pump unit is positioned in front of the engine.

6. The four-wheeled all terrain vehicle of claim 5, wherein the fuel pump unit comprises a case main body which encloses a fuel filter, a fuel pump, and a fuel pressure regulator.

7. The four-wheeled all terrain vehicle of claim 5, wherein the vehicle comprises a front wheel axis and a fuel tank, and wherein the fuel pump unit is positioned between the engine and the front wheel axis, and below the fuel tank.

8. The four-wheeled all terrain vehicle of claim 5, wherein the engine comprises a cylinder and a cylinder head, wherein the fuel supply system comprises a throttle body disposed rearwardly of the cylinder head, and wherein the fuel injector is disposed proximate the throttle body.

9. The four-wheeled all terrain vehicle of claim 8, wherein the engine comprises an air cleaner and wherein the air cleaner is disposed rearwardly of both the cylinder head and the throttle body.

10. The four-wheeled all terrain vehicle of claim 5, wherein
the fuel pump unit comprises a case main body which encloses a fuel filter, a fuel pump, and a fuel pressure regulator, the fuel pump unit further comprising a fuel delivery port formed within the case main body,
the fuel supply system comprises a fuel line and wherein the fuel line extends from the fuel delivery port to the fuel injector.

11. The four-wheeled all terrain vehicle of claim 5, wherein
the fuel pump unit is disposed between the engine and a front wheel axis, and comprises a case main body which encloses a fuel filter, a fuel pump, and a fuel pressure regulator, the case main body comprising a fuel delivery port,
the fuel supply system comprises a throttle body disposed rearwardly of a cylinder head of the engine, the fuel supply system further comprising a fuel line, such that
the fuel injector is disposed adjacent to the throttle body, and
the fuel line extends from the fuel delivery port to the fuel injector, and
an air filter is disposed behind the throttle body.
